(19) United States
(12) Patent Application Publication
(10) Pub. No.: US 2023/0144738 A1
(43) Pub. Date: May 11, 2023

(54) BATTERY PACK CHARGING SYSTEM

(71) Applicant: Black & Decker Inc., New Britain, CT (US)

(72) Inventors: James Robert CARBERRY, II, Baltimore, MD (US); Thomas C. KOHLER, Bel Air, MD (US); Karl PALM, Towson, MD (US); Rebecca SUN, Towson, MD (US); Matthew J. VELDERMAN, Baltimore, MD (US)

(21) Appl. No.: 17/983,157

(22) Filed: Nov. 8, 2022

Related U.S. Application Data
(60) Provisional application No. 63/263,790, filed on Nov. 9, 2021.

(51) Int. Cl. H02J 7/00

(52) U.S. Cl. CPC H02J 7/0044; H02J 7/0013; H02J 7/0045

(57) ABSTRACT

A commercial grade job site charging system is presented. The charging system may include a large container, for example a large metal box. The enclosure may be designed and configured to receive, via a temporary connection, relatively high input power, e.g., 480V, 3-phase, 60 A, for receiving a plurality of rechargeable, removable battery packs. The charging system may include a plurality of interior chargers of relatively lower power, e.g., 120V single phase, 15 A. The charging system may include a high power transformer to adapt the relatively high input power voltage to that of the lower power chargers. The charging system may simultaneously charge a plurality of battery packs, e.g., 32 battery packs.

### RELATED APPLICATIONS

This application claims priority under 35 U.S.C. § 119(e) to U.S. Provisional Patent Application No. 63/263,790, filed Nov. 9, 2021, titled “Battery Pack Charging System.”

### TECHNICAL FIELD

This application relates to a battery pack charging system and a method for manufacturing a battery pack charging system. In one implementation, the battery pack charging system includes a jobsite box and a plurality of battery pack chargers housed inside the jobsite box.

### BACKGROUND

The instant application describes an exemplary battery pack charging system for charging a plurality of battery packs.

Large commercial jobsites can have thousands of power tools. Adoption of cordless tools is hampered by the inability to charge battery packs in a large enough scale and at a fast enough rate to keep up with the workforce. As such, many tools remain corded despite the desire of jobsite managers to transition to cordless.

### SUMMARY

Another example embodiment of the present invention includes a commercial grade jobsite charging system. The charging system includes an enclosure. The enclosure defines an internal space/cavity/volume. The enclosure may include a top wall, a bottom wall and four side walls coupling the top and bottom walls forming a generally rectangular box. The walls define the internal space. The enclosure is weather resistant.

The charging system includes a plurality of multi-port chargers. For example, the charging system may include eight (8) multi-port chargers. Each charger my include, for example, four charging ports. The system may include a power input that is configured to receive power from an outside power source, for example a mains line or a generator. The system's input power may be at 240V and 50 A. Each charger may operate at a relatively low power level compared to the system's input power. For example, the charger power level may be at 120V and 15 A, single phase. A first set of chargers, for example four chargers, are attached to an internal surface of a first side wall. A second set of chargers, for example four chargers, are attached to an internal surface of a second side wall, the second side wall being opposed to the first side wall. Each charger may be in communication (wired or wirelessly) with a system level control module. In an alternate embodiment, each charger may be self-governing without the use of a system level control module.

The charging system may also include a power distribution unit. The power distribution unit may be mechanically/physically coupled to an internal surface of a third side wall, the third side wall between and generally perpendicular to the first and second side walls and electrically coupled to each of the plurality of chargers (either hard wired or by a plug/socket configuration).

The charging system may also include a control module. The control module may include a control circuit including processing circuitry, control circuitry, memory, communications circuitry, e.g., wired or wireless transceiver circuitry.

The charging system may include an AC power input port, a cord/plug set coupled to the AC power input port for receiving relatively high power (240V, 50 A, single phase) from a jobsite power supply.

The charging system may include a GFCI circuit breaker between the AC power input port and the power distribution unit. The power distribution unit may include a GFCI circuit breaker at its input and output ports/receptacles.

The charging system may include a fan mechanically coupled to an internal surface of a fourth side wall, the fourth side wall between and generally perpendicular to the first and second side walls and generally parallel to the third side wall. The fan may be electrically coupled to the power distribution unit. The fan may be in communication (wired or wirelessly) with the control module. The fan may be configured to move air into or out of the internal space. The fan may include an integrated temperature sensor and control module/circuit.

The charging system may include a heating element. The heating element may be electrically coupled to the power distribution unit. The heating element may be in communication (wired or wirelessly) with the control module. The heating element may include an integrated temperature sensor.

The charging system may include a display unit. The display unit may be mechanically coupled to an exterior surface of the enclosure. The display unit may be electrically coupled to the distribution unit. The display unit may be in communication (wired or wirelessly) with the control module.

The charging system may be configured to receive at least one battery pack in at least one of the plurality of charging ports and charged by the charger. The battery pack may be in communication (wired or wirelessly) with the chargers and/or the system control module.

The charging system may include a discrete temperature sensor. The discrete temperature sensor may be mechanically coupled to one of the side walls. The discrete temperature sensor may be in communication (wired or wirelessly) with the control module.

Another example embodiment of charging system may include an enclosure. The enclosure may be designed and configured to receive, via a temporary connection, relatively high input power, e.g., 480V, 3-phase, 60 A. The charging system may include a plurality of interior chargers of relatively lower power, e.g., 120V single phase, 15 A. The charging system may include a high power transformer to adapt the relatively high input power voltage to that of the lower power chargers. The charging system may simultaneously charge a plurality of battery packs, e.g., 32 battery packs.

The enclosure may be weather resistant. The enclosure may be liftable and transportable, for example, by a crane or a forklift.

The charging system may include an internet connection, e.g., WiFi or cellular, to BLE gateway for assessing BLE-capable inventory in the enclosure.

The enclosure may include a user accessible, internal or external facing power receptacles.

The charging system may include environmental controls to keep the temperature of the packs in an operating range that allows the packs to be charged.

The charging system may include pass thru connections for chaining multiple charging enclosures together.

Another example embodiment of the charging system may include an enclosure. The enclosure may be configured to receive, through a pluggable connection, a relatively high power signal, e.g., 240V, single phase, 50 A. The charging system may include a plurality of interior chargers of relatively lower power—e.g. 120V, single phase, 10 A. The charging system may include an input GFCI circuit breaker. The charging system may include a power distribution unit. The charging system may simultaneously charge a plurality of battery packs, e.g., 32 battery packs.

The enclosure may be weather resistant. The enclosure may be liftable and transportable, for example, by a crane or a forklift.

The charging system may include an internet connection, e.g., WiFi or cellular, to BLE gateway for assessing BLE-capable inventory in the enclosure.

The charging system may include environmental controls to keep the temperature of the packs in an operating range that allows the packs to be charged.

The enclosure may be securable thru an external padlock or some other type of locking mechanism.

Another example embodiment of the charging system may include an enclosure. The enclosure defines an interior (or internal) space (or volume). The enclosure contains and provides power for a plurality of battery pack chargers positioned (or housed or situated) in the interior space. The input power rating of the enclosure is greater than the input power rating of the interior chargers. The input power voltage of the enclosure is greater than the input power voltage of the interior chargers.

The interior chargers may be removable from the enclosure.

The charging system may include a BLE gateway to a long range connection, e.g., cellular, WiFi, Lora. The BLE gateway may be located within the space defined by the enclosure.

The charging system may regulate the temperature—by heating and cooling—of the interior space and hence the immediate external environment of the battery packs coupled to the battery pack chargers for maintaining the battery packs within a preferred operating range for optimal charging (4 C to 40 C). This is notably different from fan cooled chargers that blow air thru the battery, but do not regulate the surrounding environment.

The enclosure may include a plurality of circuit breakers for safely managing the current to the plurality of interior chargers.

The charging system may include an input connection suitable for temporary jobsite power connections; and a pass-thru connector of the same type (though opposite gender).

Another example embodiment of a charging system may include an enclosure. The charging system may communicate the state of charge of the battery packs on the individual, interior chargers to a charging system control module. The charging system may communicate the state of charge via a display on the enclosure, e.g., a screen, an LED indicator, via networked notification, e.g., text message, or to an endpoint enabled by an internet connection.

The enclosure may be of a similar rated power as the interior chargers. The charging system my include a power multiplexer switch transfer connection to sequentially connect the interior chargers to the enclosure power supply when the current draw of the interior chargers falls below a threshold.

The enclosure interior may be sized such that, in addition to the plurality of battery pack chargers and accompanying control equipment, a person can physically enter the interior, e.g., a Connex box, to access the interior chargers and battery packs.

The enclosure may include a fire suppression system.

Implementations of this aspect may include one or more of the following features.

Advantages may include one or more of the following.

These and other advantages and features will be apparent from the description and the drawings.

### BRIEF DESCRIPTION OF THE DRAWINGS

FIG. 1A is a top/front perspective view of an example embodiment of a charging system in accordance with the present application; FIG. 1B is a partial front/side perspective view of the charging system of FIG. 1A; FIG. 1C is a partial side elevation view of the charging system of FIG. 1A.

FIG. 2 is a section view of a first example embodiment of the charging system of FIG. 1A taken along section line A-A.

FIG. 3 is a section view of the first example embodiment of the charging system of FIG. 1A taken along section line B-B.

FIG. 4. is a section view of the first example embodiment of the charging system of FIG. 1A taken along section line C-C.

FIG. 5 is a section view of the first example embodiment of the charging system of FIG. 1A taken along section line D-D.

FIG. 6 is a top plan view of the first example embodiment of the charging system of FIG. 1A in which the top of the charging system has been removed.

FIG. 7 is a section view of a second example embodiment of the charging system of FIG. 1A taken along section line A-A.

FIG. 8 is a section view of the second example embodiment of the charging system of FIG. 1A taken along section line B-B.

FIG. 9. is a section view of the second example embodiment of the charging system of FIG. 1A taken along section line C-C.

FIG. 10 is a section view of the second example embodiment of the charging system of FIG. 1A taken along section line D-D.

FIG. 11 is a top plan view of the second example embodiment of the charging system of

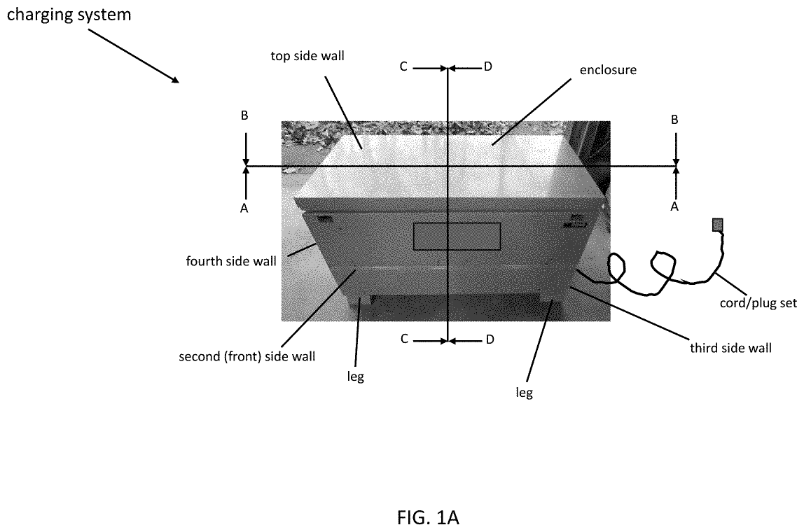

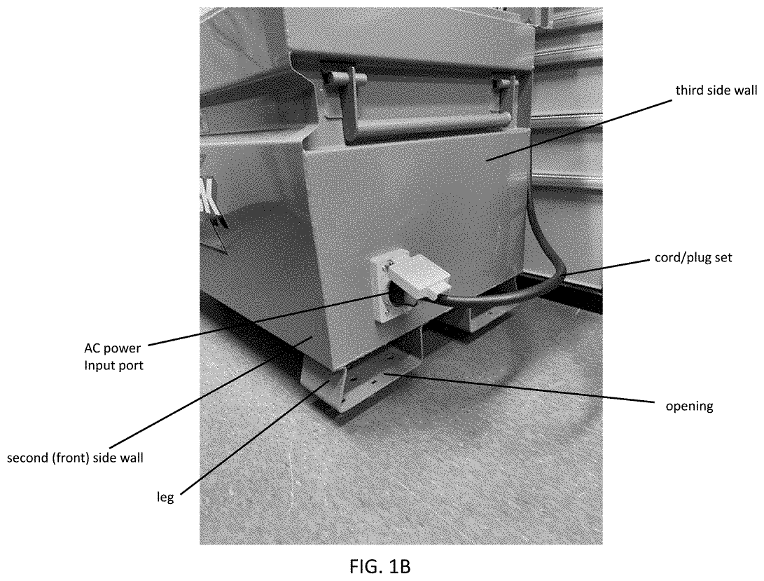

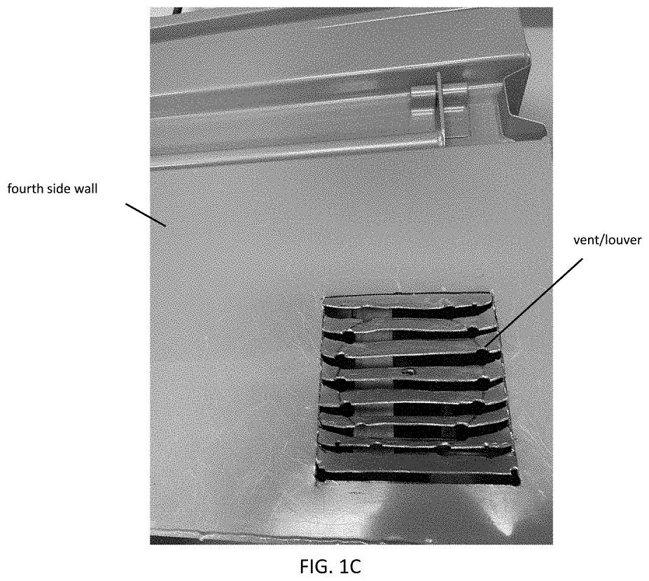

FIG. 1A in which the top of the charging system has been removed.

FIG. 12 is an example embodiment of an enclosure of the charging system of FIG. 1A.

FIG. 13 is a section view of the enclosure of FIG. 12.

FIG. 14 front elevation view of a third example embodiment of a charging system in accordance with the present application.

FIG. 15 is a front elevation view of the charging system of FIG. 14 with a set of doors open.

FIG. 16 is a front elevation view of a fourth example embodiment of a charging system in accordance with the present application.

FIG. 17 is a front/side perspective view of a fifth example embodiment of a charging system in accordance with the present application.

FIG. 18 is a front/side perspective view of the charging system of FIG. 17 with a set of doors open.

FIG. 19 is front elevation view of the charging system of FIG. 18.

FIG. 20 is front/side perspective view of a sixth example embodiment of a charging system in accordance with the present application.

FIG. 21 is a rear/side perspective view of the charging system of FIG. 20.

FIG. 22 is a front/side perspective view of the charging system of FIG. 20 with a set of doors open.

FIG. 23 is a front/side perspective view of the charging system of FIG. 22 with a plurality of battery pack chargers.

### DETAILED DESCRIPTION

Referring to FIGS. 1A, 1B, and 1C, there is illustrated an example embodiment of a battery pack charging system in accordance with the instant application. The charging system may include an enclosure. The enclosure may be generally configured or shaped as a rectangular box having a top side wall, a bottom side wall, a first side wall—also referred to as a rear wall, a second side wall—also referred to as a front wall, a third side wall and a fourth side wall. The walls of the box define an interior volume or cavity or space. The four side walls and the bottom walls may be sealed with respect to each other. These walls may be sealed by known methods such as welding or other similar methods to enable a seal between the walls to seal the interior space from the exterior environment, such as moisture and temperature. The top wall may be coupled to the rear wall by a hinge or a similar device to enable a user to open/pivot the top wall relative to the rear wall to gain access to the interior space and to seal the top wall to the four side walls (which may be sealed as noted above) to seal the interior space from the exterior environment, such as moisture and temperature.

The charging system may include a set of legs attached to the bottom wall of the enclosure. The legs rest on the ground or other supporting surface. The legs allow the enclosure to be raised off the ground or other supporting surface. The legs may include openings to allow the charging system to be lifted and relocated by, for example, a forklift or a crane.

The charging system may include an alternating current (AC) power input port. The power input port may be configured to maintain the sealing integrity of the enclosure. In other words, the power input port is a sealed port or recessed to protect against direct exposure to the exterior environmental conditions, such as temperature and moisture. The power input port may include an electromechanical connector for transmitting electricity into the enclosure. The connector may be a male or a female connector. The charging system may include a cord/plug set. The cord/plug set may be configured to transmit electricity from a power supply to the charging system. The cord/plug set may include a first connector that is configured to mate with the power input port connector. Alternatively, the cord/plug set may be hardwired to the AC power input port and to the power input port connector. The cord/plug set may include a second connector that is configured to connect to a high voltage power supply. For example, the second connector may be a male, prong connector for mating with a corresponding female socket. The female socket may be coupled to a high voltage power supply. The high voltage power supply may be, for example, 480V, 3-phase, 60 A or 240V, single phase, 50 A.

The enclosure may include a vent or louver to enable directed airflow out of the enclosure. The vent may be located in one of the side walls, for example, the fourth side wall. the vent may be configured and positioned to correspond to a fan housed in the interior space, as described in more detail below.

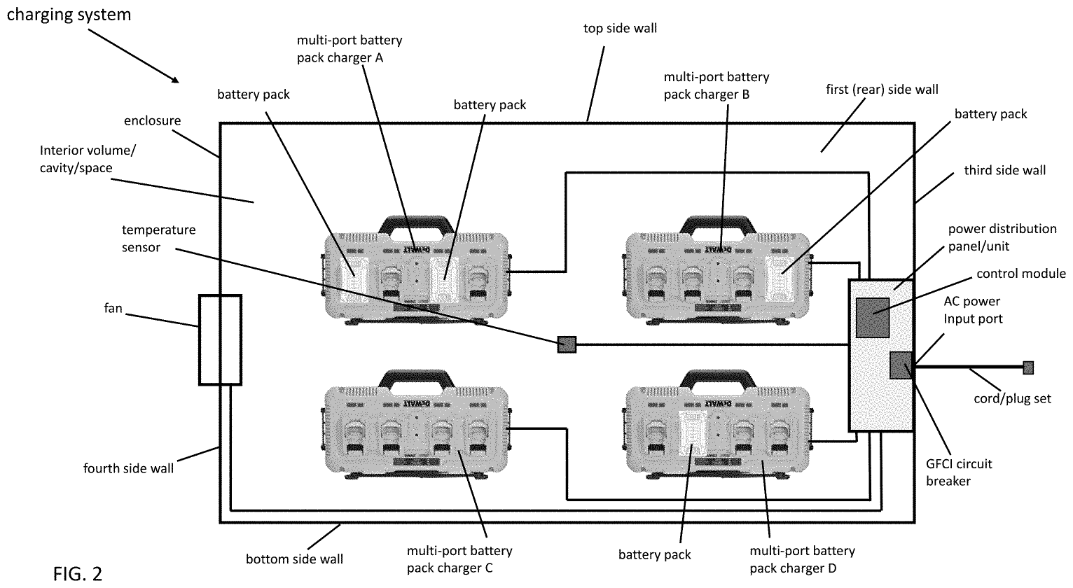

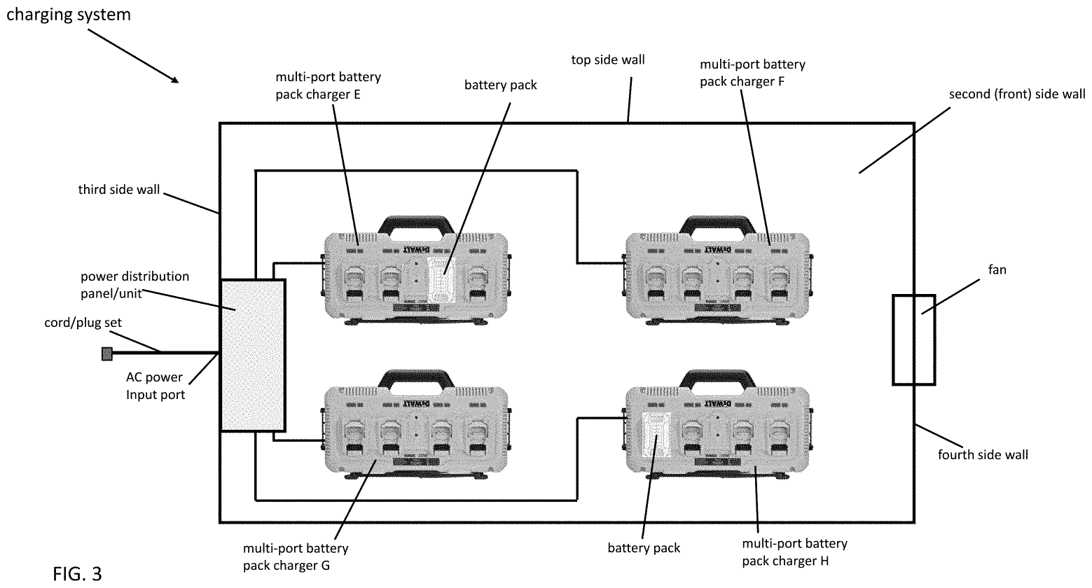

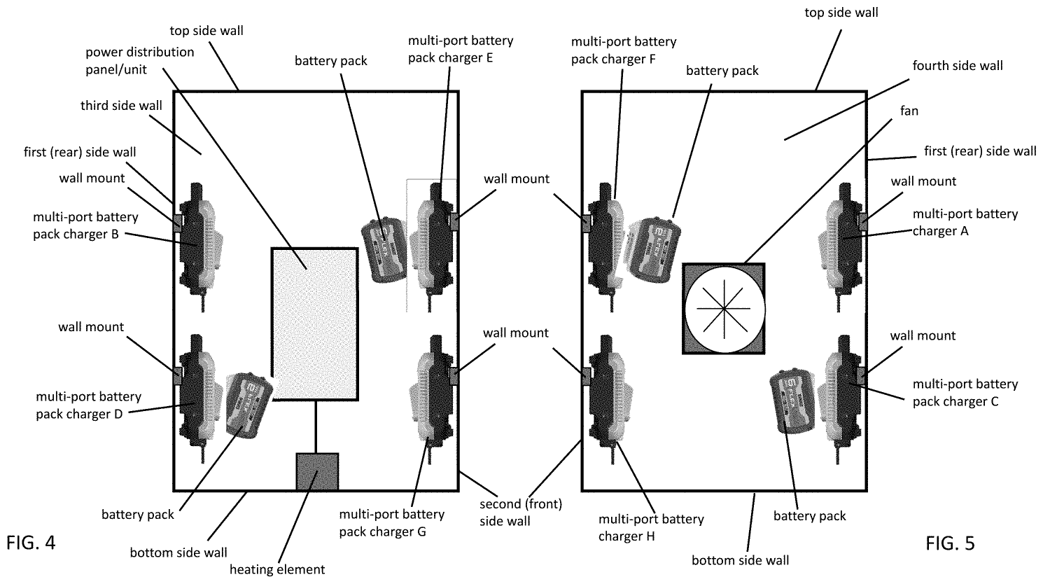

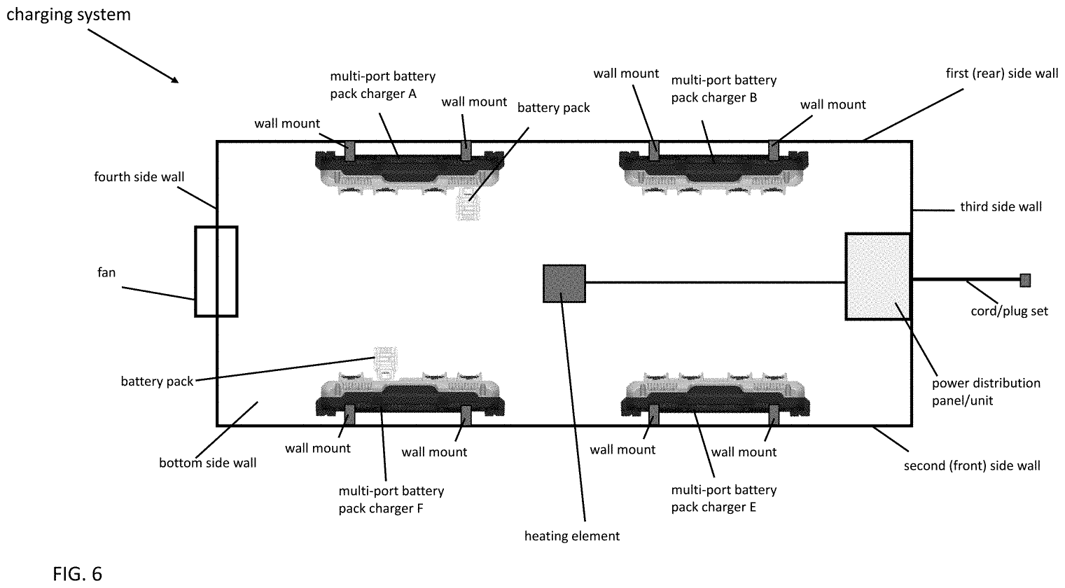

Referring FIGS. 1A, 1B, 1C and also to FIGS. 2-6, a first example embodiment of the charging system is illustrated. The charging system may include a plurality of multi-port battery pack chargers. An example of such a multi-port battery pack charger is the DCB104 sold under the DeWalt brand name. This example charging system includes eight (8) such multi-port battery pack chargers: multi-port battery pack charger A, multi-port battery pack charger B, multi-port battery pack charger C, multi-port battery pack charger D, multi-port battery pack charger E, multi-port battery pack charger F, multi-port battery pack charger G, and multi-port battery pack charger H. Alternate embodiments may include more or fewer chargers. The pack chargers A-H may be mounted to interior surfaces of the walls of the enclosure. For example, the pack chargers A-D may be mounted to the rear wall (see FIG. 2) and the pack chargers E-H may be mounted to the front wall (See FIG. 3). The pack chargers A and B may be mounted in a first upper row on the rear wall and the pack chargers C and D may be mounted in a second lower row on the rear wall. The pack chargers A and C may be mounted in a left-most (in the context of FIG. 2) column and the pack chargers B and D may be mounted in a right-most (in the context of FIG. 2) column. The pack chargers E and F may be mounted in a first upper row on the front wall and the pack chargers G and H may be mounted in a second lower row on the front wall. The pack chargers E and G may be mounted in a left-most (in the context of FIG. 3) column and the pack chargers F and H may be mounted in a right-most (in the context of FIG. 3) column. The pack chargers A-H may be mounted to the walls of the enclosure or to an internal mounting structure (as described in detail below) by a bolt, screw, rivet, retaining tab or other similar wall mounting device, as would be well known to one of ordinary skill in the art.

Each of example multi-port battery pack chargers includes four (4) ports or battery pack receptacles. Each of the ports of each of the pack chargers may receive a battery pack for charging (as will be described in more detail below). As illustrated in FIGS. 2 and 3, there are two battery packs mated or coupled to the pack charger A, there is one battery pack mated to the pack charger B, there are no battery packs coupled to the pack charger C, there is one battery pack coupled to pack charger D, there is one battery pack coupled to pack charger E, there are no battery packs coupled to pack charger F, there are no battery packs coupled to pack charger G and one battery pack couple to pack charger H. During operation of the charging system, more or fewer battery packs may be coupled to the pack chargers A-H.

The charging system may include a power distribution unit (sometimes referred to as a power distribution panel). The power distribution unit is designed and configured to distribute input power from an input port to output power to a plurality of output ports. The power distribution unit may configure and/or convert a high input power (current/voltage) to a lower output power (current/voltage). The power distribution unit may split the input power into multiple output power circuits. The power distribution unit may condition the input power in other manners, such as electrical transformation using an electrical transformer.

The AC input port may be electrically coupled to the power distribution unit. The power from the high voltage power supply is provided to the power distribution unit via the cord/plug set and the AC power input port. The AC power input port my include a GFCI circuit breaker.

The charging system may include a control module. The control module may include a plurality and variety of electrical and electronic components including but not limited to microprocessors, microcontrollers, memory circuits, sensors and switches. The various components are electrically coupled in various related circuits and circuitry. The control module and its components and circuitry may monitor and control the various components of the charging system. The control module may be housed inside the enclosure in the interior space. The control module may be incorporated into the power distribution unit or it may be discrete component.

The power distribution unit may be electrically coupled to the control module. The control module may monitor the status of the power distribution unit and control the operation of the power distribution unit. The power distribution unit may provide appropriate operating power (voltage/current) to the control module.

Each of the pack chargers A-H may be electrically coupled to the power distribution unit. The pack chargers may be removably coupled to the power distribution unit through a plug and socket connection or the pack chargers may be hard wired or fixedly wired to the power distribution unit. The power distribution unit provides the appropriate power (voltage/current) to the pack chargers. For example, the power distribution unit may convert 240V 50 A input power to 120V 15 A output power for input to the pack chargers.

Each of the pack chargers may include control circuitry and components to monitor and charge any and all of the battery packs received in a battery pack receptacle using the power received from the power distribution unit.

The charging system may include a fan. The fan may be electrically coupled to the power distribution unit and/or to the control module. The power distribution unit may provide appropriate operating power (voltage/current) to the fan. The fan may include an internal temperature sensor. The fan may turn on and off based on control settings and the internal temperature sensor. Alternatively, the fan may be powered and/or controlled by the control module. Alternatively, the charging system may include a discrete temperature sensor positioned in the interior space. The discrete temperature sensor may be electrically coupled to the control module. The control module may control the fan based on control settings and the discrete temperature sensor. The fan may move air from the interior space to outside the enclosure. The fan may move air from outside the enclosure to interior space.

The charging system may include a heating element. The heating element may be electrically coupled to the power distribution unit and to the control module. The power distribution unit may provide appropriate operating power (voltage/current) to the heating element. The heating element may include an internal temperature sensor. The heating element may turn on and off based on control settings and the internal temperature sensor.

Alternatively, the heating element may be controlled by the control module. Alternatively, the charging system may include a discrete temperature sensor positioned in the interior space. The discrete temperature sensor may be electrically coupled to the control module. The control module may control the heating element based on control settings and the discrete temperature sensor.

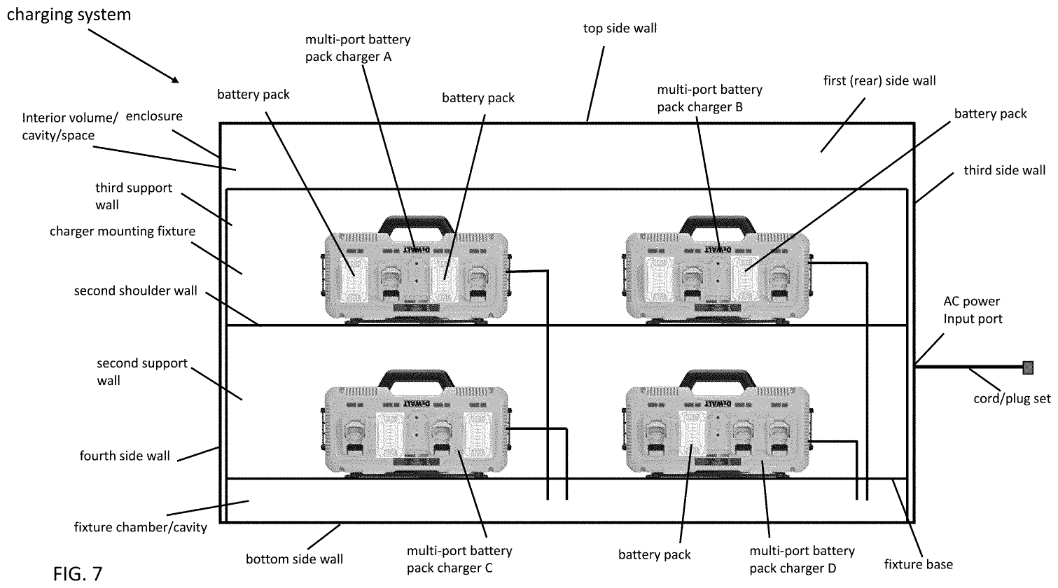

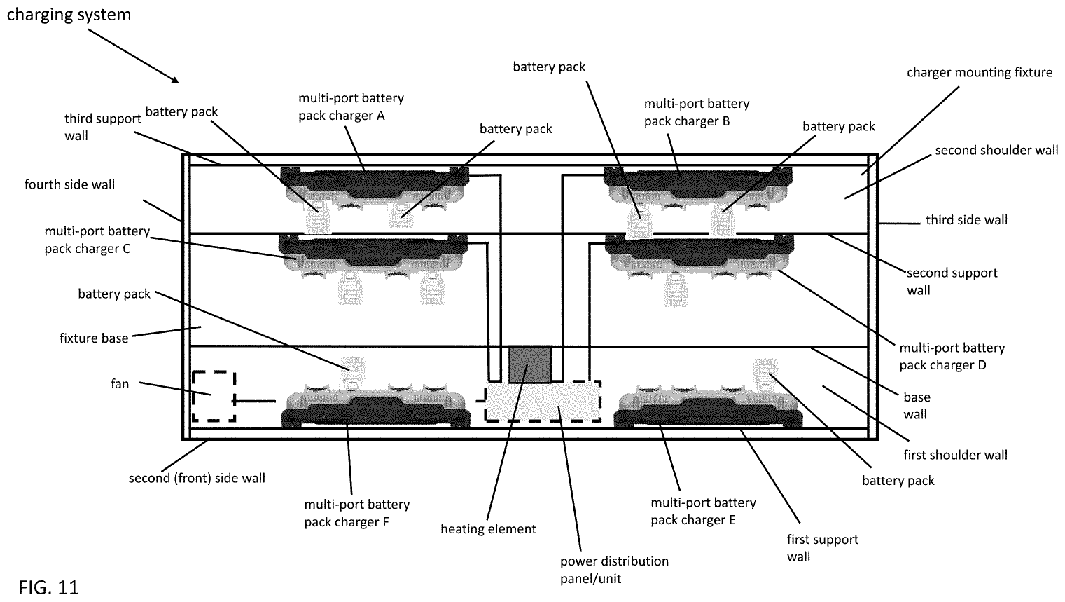

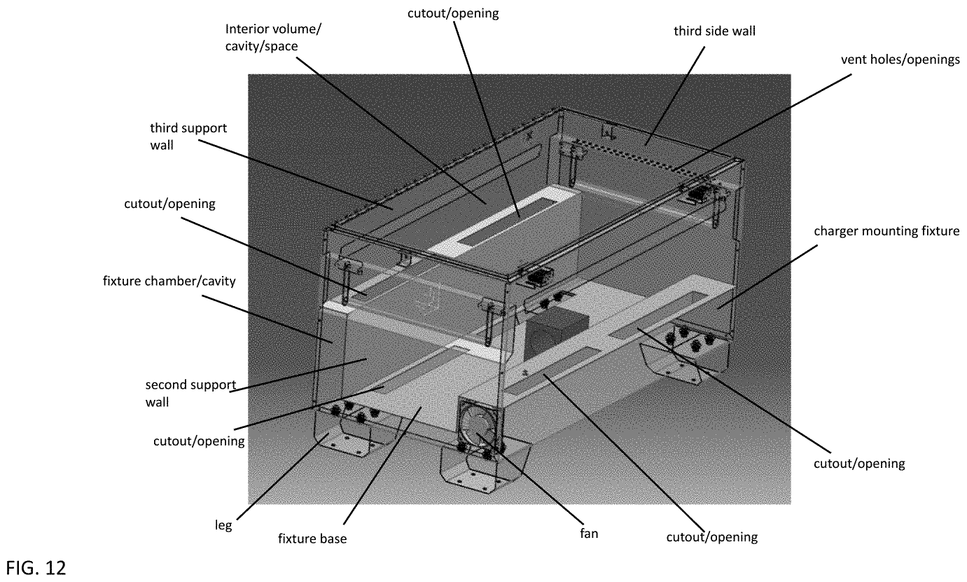

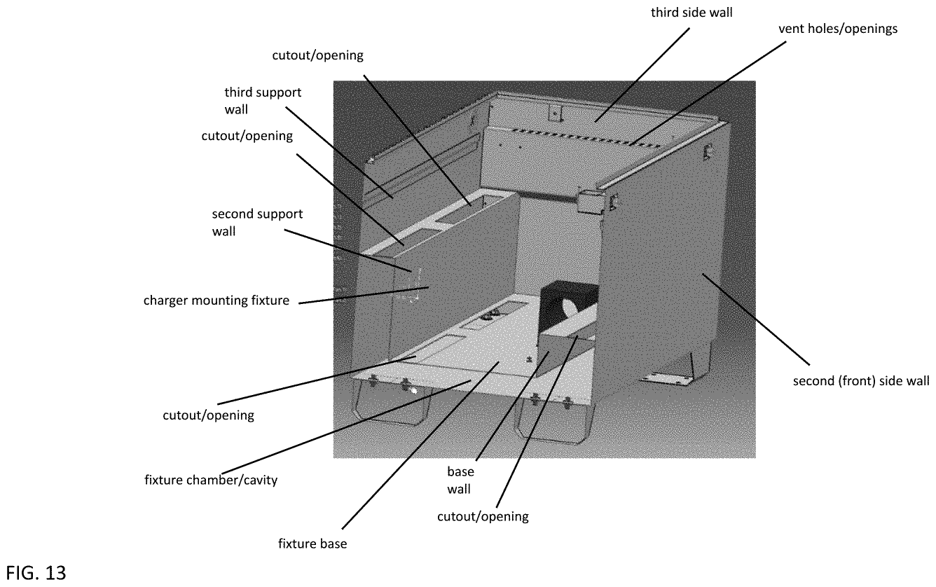

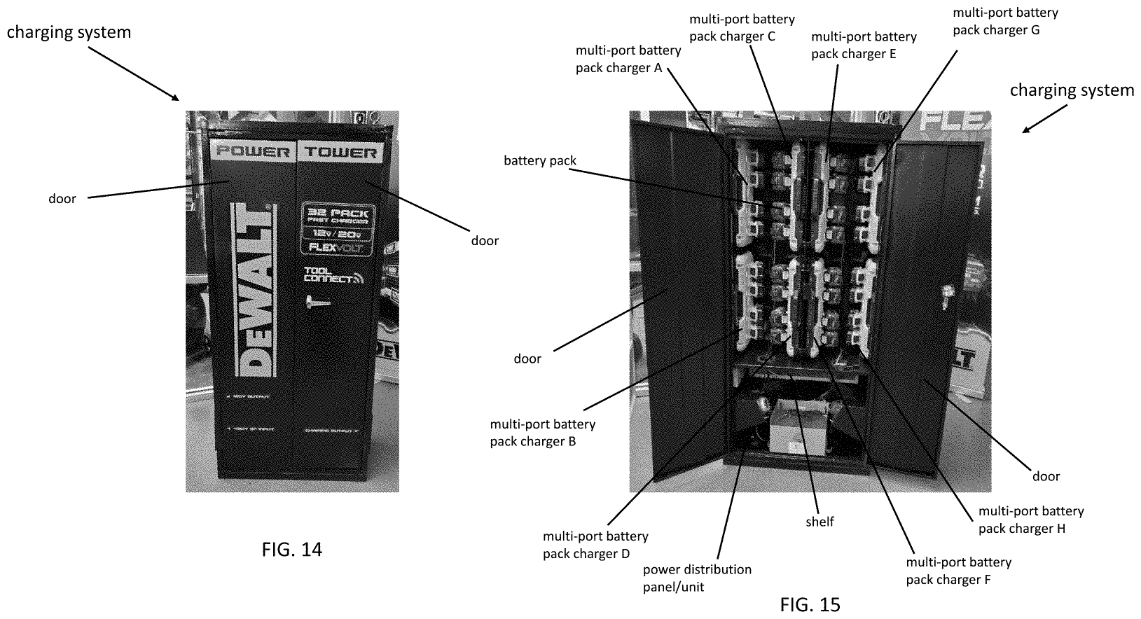

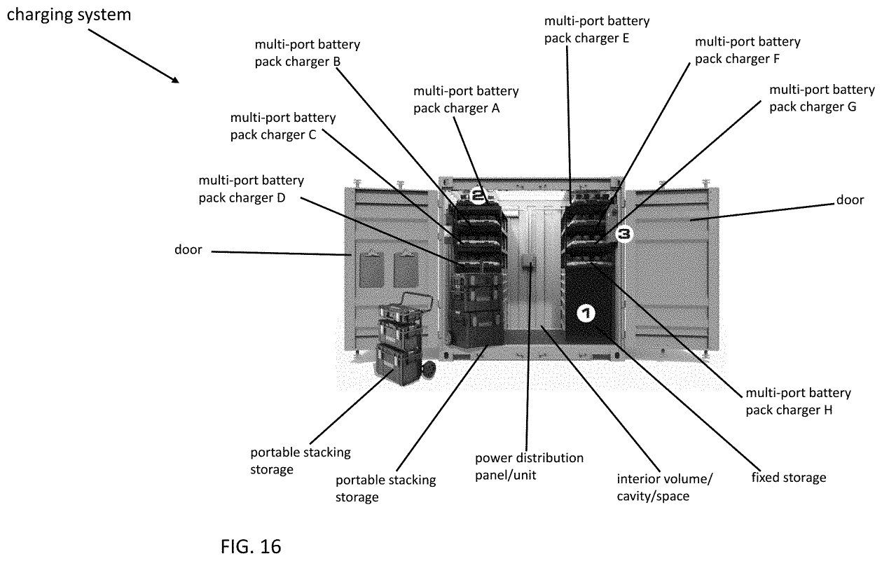

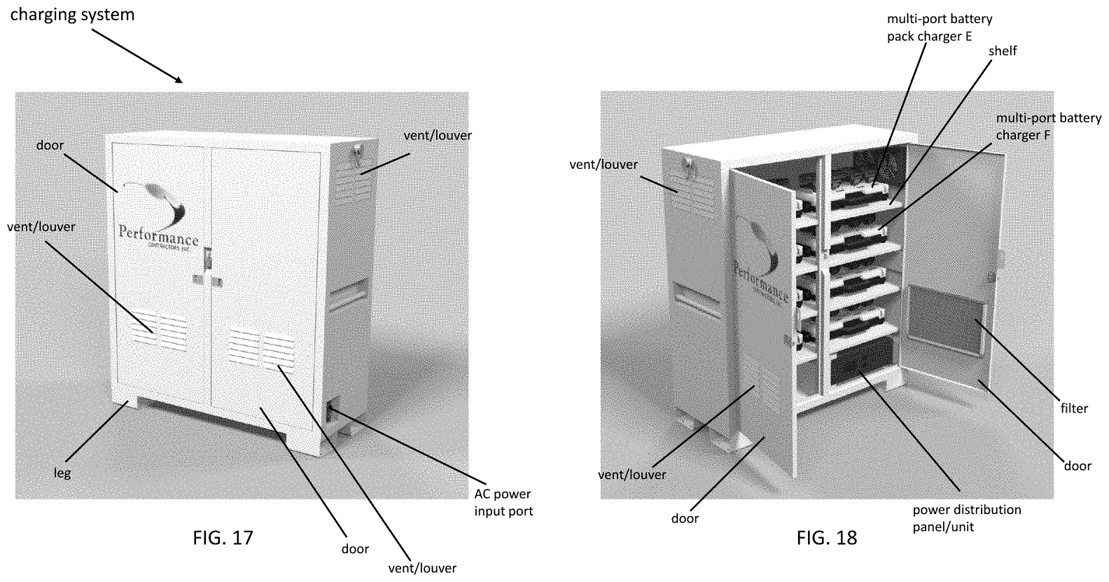

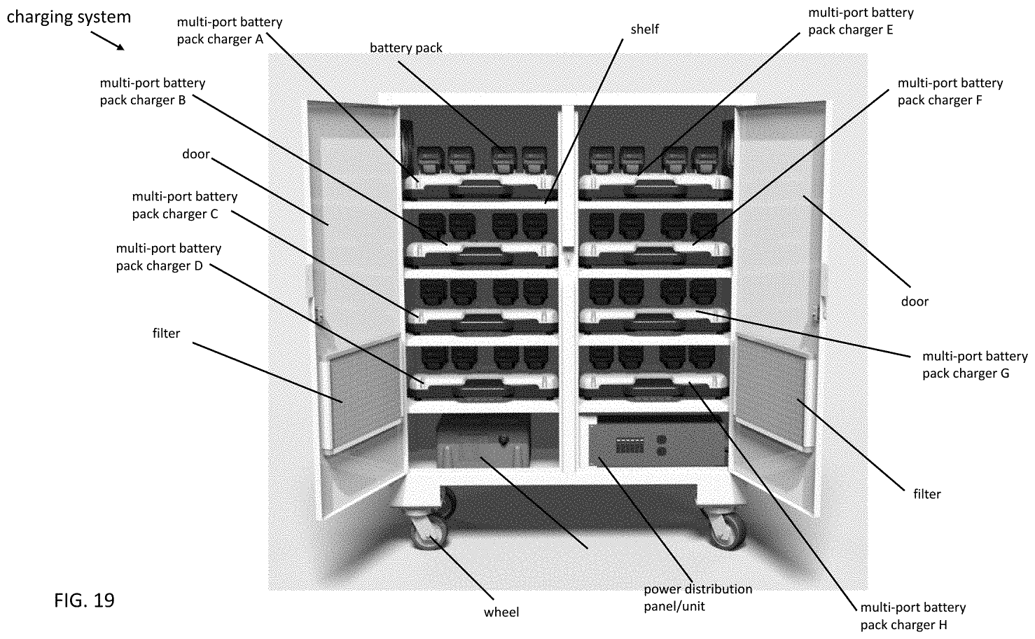

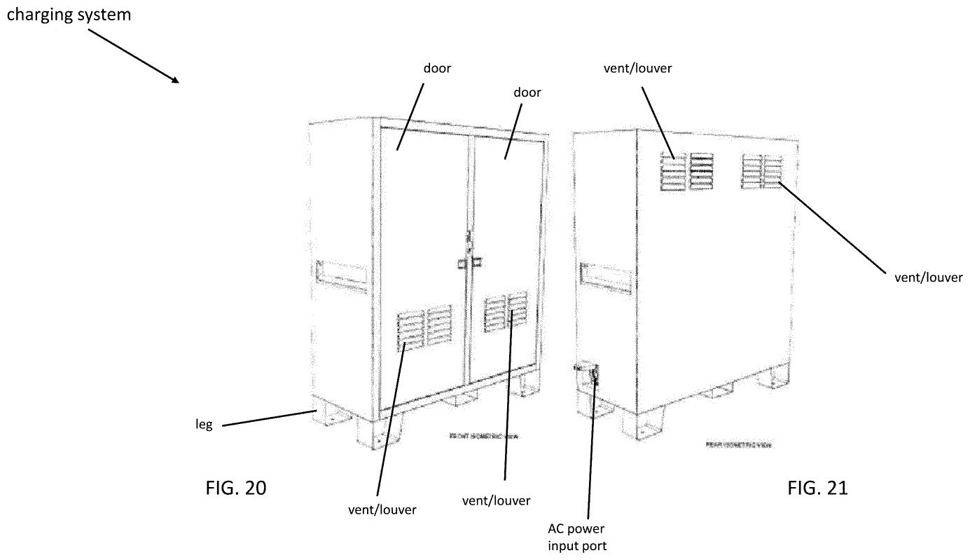

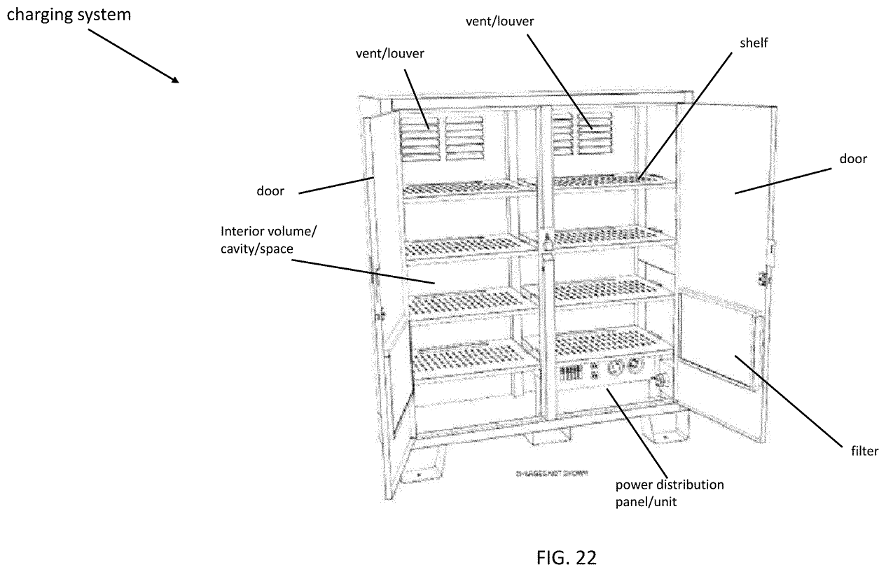

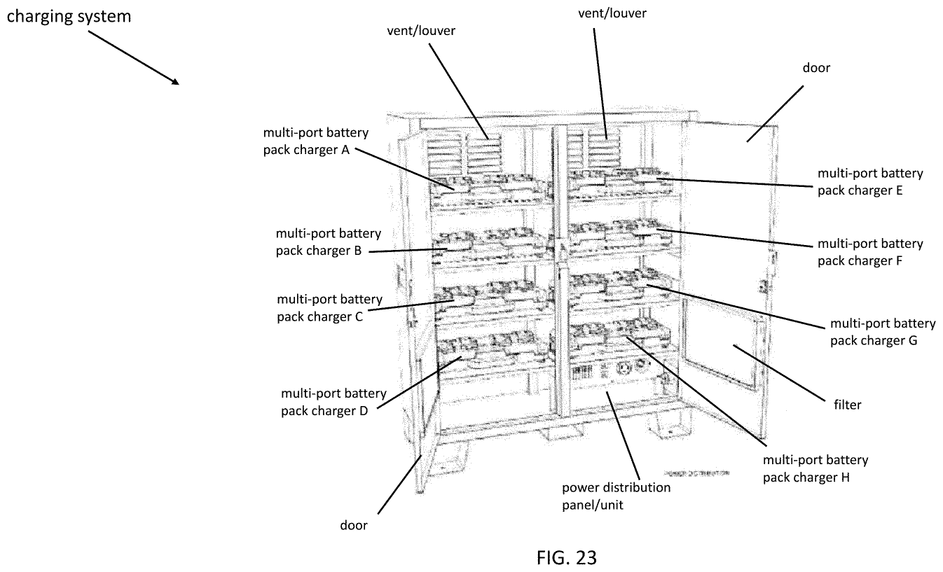

Referring FIGS. 1A, 1B, 1C and also to FIGS. 7-13, a second example embodiment of the charging system is illustrated. The charging system may include a plurality of multi-port battery pack chargers. An example of such a multi-port battery pack charger is the DCB104 sold under the DeWalt brand name. This example charging system includes six (6) such multi-port battery pack chargers: multi-port battery pack charger A, multi-port battery pack charger B, multi-port battery pack charger C, multi-port battery pack charger D, multi-port battery pack charger E, and multi-port battery pack charger F. Alternate embodiments may include more or fewer chargers. In alternate embodiments, the battery pack chargers may include more or few charging ports. For example, the battery pack chargers may have a single port or they may have two ports. The charging system may include battery pack chargers having different number of ports. For example, the charging system may include a battery pack charger having a single port and a battery pack charger having four ports. The power input to this example charging system may be 240V and 30 A.

This example embodiment of the charging system may include a charger mounting fixture. The charger mounting fixture may be a prefabricated unit that may be installed into the interior space. The charger mounting fixture facilitates mounting the pack chargers and efficient positioning of the pack chargers within the interior space.

The charger mounting fixture may include a fixture base. When the charger mounting fixture is installed in the enclosure, the fixture base may be generally parallel to bottom wall and offset from the bottom wall a distance X1. The fixture base may be of a generally rectangular shape having a length L (less than the distance between the third and fourth walls) and a width W (less than the distance between the first and the second walls).

A base wall may extend from a first length edge of the fixture base in a first direction.

The first direction may be generally perpendicular to the fixture base. The base wall may have a length L and a height X2. A first shoulder wall may extend from a second length edge of the base wall in a second direction. The second direction may be generally perpendicular to the base wall and may be generally parallel to the fixture base. A first support wall may extend from a second length edge of the first shoulder wall in the first direction. The first support wall may have a length L and a height X3.

A second support wall may extend from a second length edge of the fixture base in the first direction. The second support wall may have a length L and a height X4. A second shoulder wall may extend from a second length edge of the second support wall in a direction generally opposite to the second direction. A third support wall may extend from a second length edge of the second should wall in the first direction. The third support wall may have a length L and a height X5.

When the charger mount fixture is installed in the interior space of the enclosure may positioned in the enclosure as illustrated in FIGS. 7-11. The charger mount fixture may be made of metal or plastic or other sturdy material. In an alternative embodiment, the charger mount fixture may be manufactured simultaneously with the enclosure and may be fixed to the enclosure.

When the charger mount fixture is installed in the enclosure, the charger mount fixture, the first, second, third, fourth and bottom side walls may form a fixture chamber or cavity. The first and second should walls may include cutouts or openings in the wall. These cutouts provide access to the fixture chamber. When then pack chargers are mounted to the support walls air outlet vents in the pack chargers may align with the cutouts. Additionally, the cutouts may be sized and configured to receive a power transfer cord from the pack charger into the fixture chamber.

The power distribution unit may be positioned in the fixture chamber in a space generally defined by the base wall, the bottom side wall, the front wall, the first shoulder wall, the third side wall and the fourth side wall. The fan may be positioned in the fixture chamber in a space generally defined by the base wall, the bottom side wall, the front wall, the first shoulder wall, the third side wall and the fourth side wall.

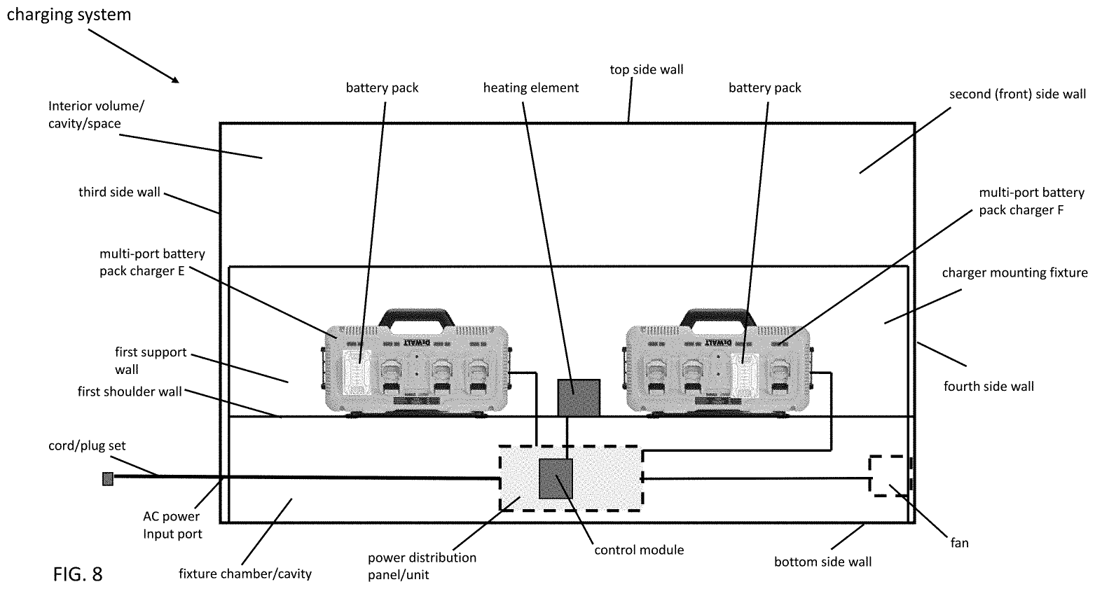

As illustrated in FIGS. 8-11, the pack chargers E and F may be mounted to the first support wall and as illustrated in FIGS. 7, 9-11, the pack chargers A and B may be mounted to the third support wall and the pack chargers C and D may be mounted to the second support wall.

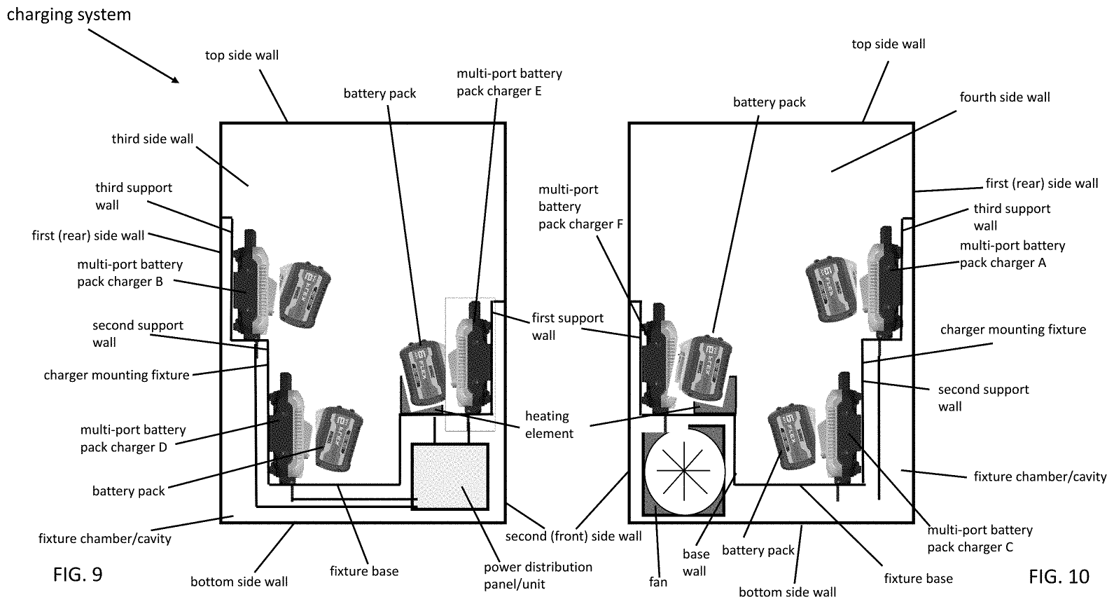

Referring to FIGS. 9, 10, and 11, the pack chargers C and D of the lower row may be offset from the pack chargers A and B of the upper row. The lower row of pack chargers may be offset from the upper row of pack chargers towards a center of the interior space. In other words, the lower row of pack chargers C and D are generally in a first vertical plane and the upper row of pack chargers A and B are generally in a second vertical plane, wherein the first vertical plane is generally parallel to the second vertical plane and wherein the first vertical plane is offset from the second vertical plane. This offset configuration allows a user easier access to the pack chargers in the lower row to more easily place and remove battery packs from the pack chargers.

Wiring for the charging system may run through the fixture chamber. For example, the power cords connecting the pack chargers to the power distribution unit and/or the control module may run through the fixture chamber and the power wiring connecting the fan and the heater to the power distribution unit and/or the control module may run through the fixture chamber and the power cord connecting the AC power input port to the power distribution unit may run through the fixture chamber.

As noted above, when the pack chargers are mounted to the charger mounting fixture outlet vents of the pack charger may align with the corresponding cutout in the corresponding shoulder wall. The pack charger may also include air inlet vents and a fan for moving air from the pack charger inlet vent to the pack charger outlet vent. The fan may move air over various heat generating components of the pack charger or over the battery packs. The pack charger fan may move air from the interior space through the pack charger and into the fixture chamber. The charging system fan my move air from the fixture chamber to outside the enclosure through the enclosure vent/louver.

Referring to FIGS. 12 and 13, the enclosure may include a plurality of vent holes or openings in the third side wall to allow cool air from outside the enclosure to be brought into the enclosure to cool the battery packs and/or the pack chargers and/or the power distribution unit.

Referring to FIGS. 14 and 15, there is illustrated a third example embodiment of a charging system in accordance with the present application. Similar to the previous embodiments, this example embodiment includes an enclosure. The enclosure may be a standing cabinet. The cabinet may be constructed of metal or plastic or other durable material. The enclosure may have two center opening doors wherein each door is hingedly fixed to an opposing side wall. As illustrated in FIG. 15, the doors may open to provide access to the interior space. The charging system may include a plurality of battery pack chargers A-H. The pack chargers may be arranged and positioned vertically and mounted to side walls of the enclosure and/or to internal vertical shelves. The charging system may also include a power distribution unit.

Referring to FIG. 16, there is illustrated a fourth example embodiment of a charging system in accordance with the present application. Similar to the previous embodiments, this example embodiment includes an enclosure. The enclosure may be a standing cabinet. The cabinet may be constructed of metal or plastic or other durable material. The enclosure may have two center opening doors wherein each door is hingedly fixed to an opposing side wall. As illustrated in FIG. 16, the doors may open to provide access to the interior space. The interior space may be large enough for an adult person to enter the interior space. The charging system may include a plurality of battery pack chargers A-H. The pack chargers may be arranged and positioned on internal horizontal shelves. The shelves and chargers may be mounted to allow for portable stacking storage to be moved into the interior space for storage. The interior space may also include a fixed storage unit for storing various power tools and/or power tool accessories. The charging system may also include a power distribution unit. The power distribution unit may be mounted to a rear wall. The power distribution unit may be electrically coupled to an AC power input port and to each of the multi-port battery pack chargers A-H.

Referring to FIGS. 17, 18, and 19, there is illustrated a fifth example embodiment of a charging system in accordance with the present application. Similar to the previous embodiments, this example embodiment includes an enclosure. The enclosure may be a standing cabinet. The cabinet may be constructed of metal or plastic or other durable material. The enclosure may have two center opening doors wherein each door is hingedly fixed to an opposing side wall. As illustrated in FIG. 19, the doors may open to provide access to the interior space. Each of the doors may include a vent or louver to enable movement of air into and out of the enclosure. The enclosure may include a filter on an interior of each of the doors at the vent/louver to filter any air moving into the enclosure. The enclosure may include additional vents/louvers on the side walls. The charging system may include a plurality of battery pack chargers A-H. The pack chargers may be arranged and positioned on internal horizontal shelves. The charging system may also include a power distribution unit. The power distribution unit may be placed or mounted to a shelf. The power distribution unit may be electrically coupled to an AC power input port and to each of the multi-port battery pack chargers A-H. As illustrated in FIGS. 17 and 18, the enclosure may include a plurality of legs. The legs may include openings for receiving the forks of a forklift for moving the enclosure. Alternatively, as illustrate in FIG. 19, the enclosure may include a plurality of wheels for moving the enclosure.

Referring to FIGS. 20-23, there is illustrated a sixth example embodiment of a charging system in accordance with the present application. Similar to the previous embodiments, this example embodiment includes an enclosure. The enclosure may be a standing cabinet. The cabinet may be constructed of metal or plastic or other durable material. The enclosure may have two center opening doors wherein each door is hingedly fixed to an opposing side wall. As illustrated in FIG. 19, the doors may open to provide access to the interior space. Each of the doors may include a vent or louver to enable movement of air into and out of the enclosure. The enclosure may include a filter on an interior of each of the doors at the vent/louver to filter any air moving into the enclosure. The enclosure may include additional vents/louvers on the rear wall. The charging system may include a plurality of battery pack chargers A-H. The pack chargers may be arranged and positioned on internal horizontal shelves. The charging system may also include a power distribution unit. The power distribution unit may be places or mounted to a shelf. The power distribution unit may be electrically coupled to an AC power input port and to each of the multi-port battery pack chargers A-H. As illustrated in FIGS. 17 and 18, the enclosure may include a plurality of legs. The legs may include openings for receiving the forks of a forklift for moving the enclosure.

Numerous modifications may be made to the exemplary implementations described above. These and other implementations are within the scope of this application.

1. A commercial grade jobsite charging system, comprising an enclosure, the enclosure including a top wall, a bottom wall, and four side walls coupling the top wall and the bottom wall forming a generally rectangular box defining an internal cavity, a plurality of multi-port chargers, a power input that is configured to receive power from an outside power source, each charger operable at a relatively low power level compared to the power input, a first set of chargers are attached to an internal surface of a first side wall, a second set of chargers are attached to an internal surface of a second side wall, the second side wall being opposed to the first side wall.
